(19) United States
(12) Patent Application Publication
(10) Pub. No.: US 2017/0316393 A1
(43) Pub. Date: Nov. 2, 2017

(54) System, Apparatus And Method For Linking Financial Accounts To A Subscription Service And Waiving Select Fees Of Those Linked Financial Accounts

(71) Applicant: Cullen/Frost Bankers, Inc., San Antonio, TX (US)

(72) Inventors: Robert A. Berman, San Antonio, TX (US); Ana Maria Beach, San Antonio, TX (US); Ericka Lynn Pullin, Floresville, TX (US)

(21) Appl. No.: 15/499,294

(22) Filed: Apr. 27, 2017

Related U.S. Application Data
(60) Provisional application No. 62/328,235, filed on Apr. 27, 2016.

(51) Int. Cl. G06Q 20/10; G06Q 20/14

(52) U.S. Cl. CPC G06Q 20/102; G06Q 20/145

(57) ABSTRACT

Apparatus, system and method for waiving at least a portion of financial account service fees is provided. The apparatus, system and method include enrolling into a flat-fee subscription service and, resulting therefrom, waiving certain fees associated with select financial accounts linked to that subscription service. Enrollment and management of financial accounts can be performed across a network by a database manager upon a database containing not only financial accounts, but also customer profiles associated with those financial accounts.

### RELATED APPLICATIONS

This patent application claims priority to U.S. Provisional Patent Application Ser. No. 62/328,235, which is incorporated by reference herein.

### TECHNICAL FIELD OF THE INVENTION

This invention relates to financial accounts and, more particularly, to enrolling one or more financial accounts into a subscription flat fee or fixed fee service resulting in waiver of certain fees normally associated with one or more accounts enrolled in the subscription service.

### BACKGROUND

A financial institute, such as a bank, may issue one or more financial accounts to a customer. Most customers have a checking account, however, many customers have other financial accounts, such as savings accounts, money market accounts, health savings accounts, etc. Depending on whether the customer also has a business, the customer can also have various financial accounts associated with that business. A customer can therefore have, in some instances, numerous financial accounts, each used for a different purpose.

In addition to a customer having multiple accounts for different purposes, a customer can also be part of a household. Where each member of that household have multiple financial accounts. For example, a father and mother may have both business and personal financial accounts, and each child can have a savings account and, depending on their ages, possibly also multiple checking and/or money market accounts. For example, there can be possibly upwards of a half dozen or more financial accounts associated with that household.

Each financial account typically bears certain fees charged by the financial institution to that user and/or household. For example, there are monthly fees associated with each account, usage-based fees, balance-based fees, and possibly more fees such as overdraft fees, wire transfer fees, stop-pay fees, etc. If a user or household has multiple financial accounts, each receiving fees on a monthly basis, or based on usage or balances, the total fees charged each month by the financial institution can be quite large and financially burdensome to a large household with multiple financial accounts. As a consequence, many households purposefully avoid unduly opening financial accounts, even though it would be convenient from an accounting or bookkeeping perspective to keep the funds separate.

It would therefore be desirable to provide an apparatus, system and method for aggregating two or more financial accounts into a financial product that, as a result of paying a single flat fee subscription amount, various monthly fees, usage-based fees, balance-fees, and other fees associated with each financial account would be waived. A need therefore exists in implementing a flat-fee subscription service in the financial sector by a financial institution that would link two or more financial accounts of a user or across users within a household that would allow the user or household to open as many financial accounts as necessary yet without the concern of being billed certain fees for each financial account certain that in the past had been traditionally applied to each financial account. The flat-fee subscription service would waive those traditional fees associated with each account and give the user the freedom to open multiple accounts and be charged a single periodic subscription fee for those multiple accounts without the deleterious effects of receiving numerous, so-called “nuisance” fees conventionally associated with each financial account.

### SUMMARY OF THE INVENTION

The problems outlined above are in large part solved by providing an apparatus, system and method that waives certain fees associated with one or more financial accounts of a user or across a household of users. The fees traditionally charged against those accounts, such as monthly fees, usage-based fees, balance-based fees are waived in favor of a single flat-fee subscription amount applicable across all accounts linked to the subscription service. The subscription amount is fixed and periodically applied across one or more linked accounts of a user or a household of users. Resulting from the subscription service product hereof, the user or a household of users each having multiple accounts simply pays one periodic flat-fee amount across all select financial accounts and user financial accounts within a household. If desired, the user can add financial accounts of a friend or relative (or any person he/she chooses), even though such persons are not living in the same house or part of the user's family. Moreover, the subscription service can be applied to both personal and business relationships, and can include personal and business depository financial accounts (e.g., checking, savings, MMA, HSA) and brokerage financial accounts. Thus, the definition of a “household” can be broadly applied to any desired group of individuals, and not necessarily to individuals living under the same roof or part of a family. The definition of “financial accounts” can also be broadly applied to both business or personal financial accounts of one or more individuals within a pre-defined group.

According to one embodiment, an apparatus for managing financial accounts is provided. The apparatus comprises a database that includes data corresponding to at least two financial accounts having a relationship code. An input/output device is coupled to the database for receiving an instruction to fetch the relationship code and to link the at least two financial accounts to a flat-fee subscription service. The flat-fee subscription service to which a user enrolls will waive a set of fees associated with the at least two select financial accounts. A database manager can be coupled between the database and the input/output device, and a graphical user interface (GUI) can be produced by the input/output device. The GUI is configured for receiving the instruction to link the financial accounts to a flat-fee subscription service, wherein the instruction is received either over a wide area network (WAN) or a local area network (LAN). Moreover the apparatus, system and method hereof also allows for de-enrollment, or cancelling of a subscriber, one or more financial accounts from a subscription, or one or more users from a linked group of users belonging that that subscription.

The financial accounts that are waived can be selected from a group consisting of checking accounts, savings accounts, money market accounts, health savings accounts and/or brokerage accounts. The flat-fee subscription service can apply a periodic single said flat fee to the at least two financial accounts of a user or amongst users within a household. The set of fees that are waived are selected from a group consisting of the conventional monthly fees charged to each account, usage-based fees, balance-based fees, etc. The set of fees that are waived can also be selected from a group consisting of a stop-pay fee, overdraft transfer fee, wire transfer fee, and/or electric bill pay fee, as well as others.

According to a further embodiment, a system for managing financial accounts is provided. The system includes a server having a database comprising data corresponding to at least one financial account, and preferably at least two financial accounts. The server can further include a database manager operably coupled to assign a flag to the at least two financial accounts. The WAN can be coupled between the server and the terminal for receiving an instruction from the terminal to the database manager for linking at least two financial accounts, for example, and for assigning the flag to the at least two financial accounts indicating waiver of a set of fees associated with the at least two financial accounts.

According to one embodiment, the WAN can comprise the Internet, and the server can comprise a web server. The flag can comprise at least one binary hit of information, and the terminal can comprise a computer or a mobile phone.

According to yet further embodiment, a method is provided for managing a financial account, and preferably at least, two financial accounts. The method comprises enrolling the at least two financial accounts into a flat-fee subscription service where the flat-fee is payable on a regular, periodic basis. A flag can be set associated with the at least two financial accounts indicating a waiver of a set of fees associated with both the at least two financial accounts during the time in which the flat-fee is paid. Customers can then be billed the flat-fee on a regular, periodic basis, acknowledging that the traditional fees associated with each linked account are waived in favor of the flat-fee subscription service amount.

### BRIEF DESCRIPTION OF THE DRAWINGS

Other objects and advantages of the invention will become apparent upon reading the following detailed description and upon reference to the accompanying drawings in which:

FIG. 1 is a schematic diagram of an apparatus used to enroll and manage financial accounts and the waiver of certain fees associated with those accounts;

FIG. 2 is a flow diagram of a method for enrolling and managing the financial accounts and the waiver of certain fees associated with those accounts; and

FIG. 3 is a schematic diagram of a system used to enroll and manage financial accounts, and fees associated therewith, either through mail, a browser or a mobile application.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF PREFERRED EMBODIMENTS

Turning now to the drawings, FIG. 1 illustrates a schematic diagram of an apparatus used to enroll and manage certain financial accounts, and moreover an apparatus used to waive certain fees associated with those accounts. A computing device 10 alternatively known as a server or, in some instances, a web server, may be used according to one embodiment of the present invention. The computing device 10 may have a processor 12 for controlling overall operation of the computing device 10 and its associated components, including a memory 14. According to one example, memory 14 can include volatile and nonvolatile memory, including solid state memory (e.g., RAM, ROM, PROM, etc.), and possibly a magnetic memory device. Input/output module 16 may include any device needed to input data, and may include also any device to output data. Input/output module 16 can include, for example, a keypad and/or stylus, along with a touch screen or a screen that is rendered as having a GUI for entering data. For example, the data can be entered in certain fields of the GUI, and the input/output module 16 can output the GUI upon a screen of, for example, a computer monitor. The GUI can be presented locally, or as described below, to a terminal across a local area network (LAN) or a wide area network (WAN) via a LAN or WAN interface.

Executable instructions can be stored within memory 14, and executed upon by processor 12. When executed upon, computing device 10 can perform various functions, including the linking of financial accounts and waiver of certain fees associated with those accounts.

Memory 14 may store instructions used by computing device 10, such as the operating system instructions 18, as well as application of programs 20 within a database manager. Various applications or general database management instructions are often times referred to as middleware instructions, all of which can be stored in the database manager portion of memory 14.

Also stored in memory 14 is data within a database 22. The data includes customer information, and specifically the transaction information data needed to link financial accounts and manage those financial accounts, as well as the customer profile information data pertaining to those financial accounts. Moreover, the data can include certain flag bits that indicate whether certain financial accounts can have their traditional fees waived in favor or the flat-fee subscription service hereof.

Computing device 10 may operate in a networked environment supporting connections to one or more remote computers, sectors, terminals 40 and 42. Terminals 40 and 42 may be servers or personal computers, such as portable computers or desktop computers. The portable computers can be personal digital assistants (PDA) or mobile phones.

For example, the network connections depicted in FIG. 1 include a LAN interface 44 and a WAN interface 46, but may also include other networks. When used in a LAN network environment, computing device 10 is connected to the LAN interface 44. When used in a WAN network environment, computing device 10 may include a modem or other means of establishing communication over WAN, such as the Internet 48.

It will be appreciated that the network connections shown are illustrative and other means of establishing a communication link between computing devices may be used. The existence of any of various well-known protocols such as TCP/IP, Ethernet, FTP, HTTP and the like is presumed, and a system can be operated in a client-server configuration to permit a user to retrieve web pages from a web based server computing device 10. Moreover, such web pages can include a GUI with fields in which a user at terminals 40 or 42 can input data. If communication occurs over a WAN, any of the various conventional web browsers can be used to display and manipulate data on web pages, and specifically data on a GUI presented as a web page. Thus, a GUI can be presented either across a WAN or a LAN, as well as local to the computing device 10 in which a user can enter information needed to link financial accounts to a flat-fee subscription service and manage those accounts not only for purposes of waiving certain fees, but also to fixed fee or flat fee invoice the customer across multiple accounts.

Customer profile or attribute information, including financial account information, may be stored in memory 14. The attribute information may be processed by an application, such as an application drawn from the database manager 20. One or more such applications may include one or more mechanisms that may be used to perform program enrollment, linking financial accounts for purposes of a single flat-fee subscription, detecting financial account usage, waiving certain fees associated with those financial accounts, and periodically invoicing based on the enrollment to the flat-fee subscription service associated therewith.

The invention may be operational with numerous other general purpose or special purpose computing system environments or configurations. Examples of well-known computing systems, environments, and/or configurations suitable for use with the preferred embodiments include, but are not limited to, personal computers, server computers, hand-held or laptop devices, mobile phones and/or other multiprocessor systems, microprocessor-based systems, set top boxes, programmable consumer electronics, network PCs, minicomputers, mainframe computers, distributed computing environments that include any of the above systems or devices, and the like.

The preferred embodiments may be described in the general context of computer-executable instructions, such as program modules, being executed by a computer. Generally, program modules include routines, programs, objects, components, data structures, etc. that perform particular tasks or implement particular data types. The preferred embodiments may also be practiced in distributed computing environments where tasks are performed by remote processing devices that are linked through a communications network. In a distributed computing environment, program modules may be located in both local and remote computer storage media including memory storage devices.

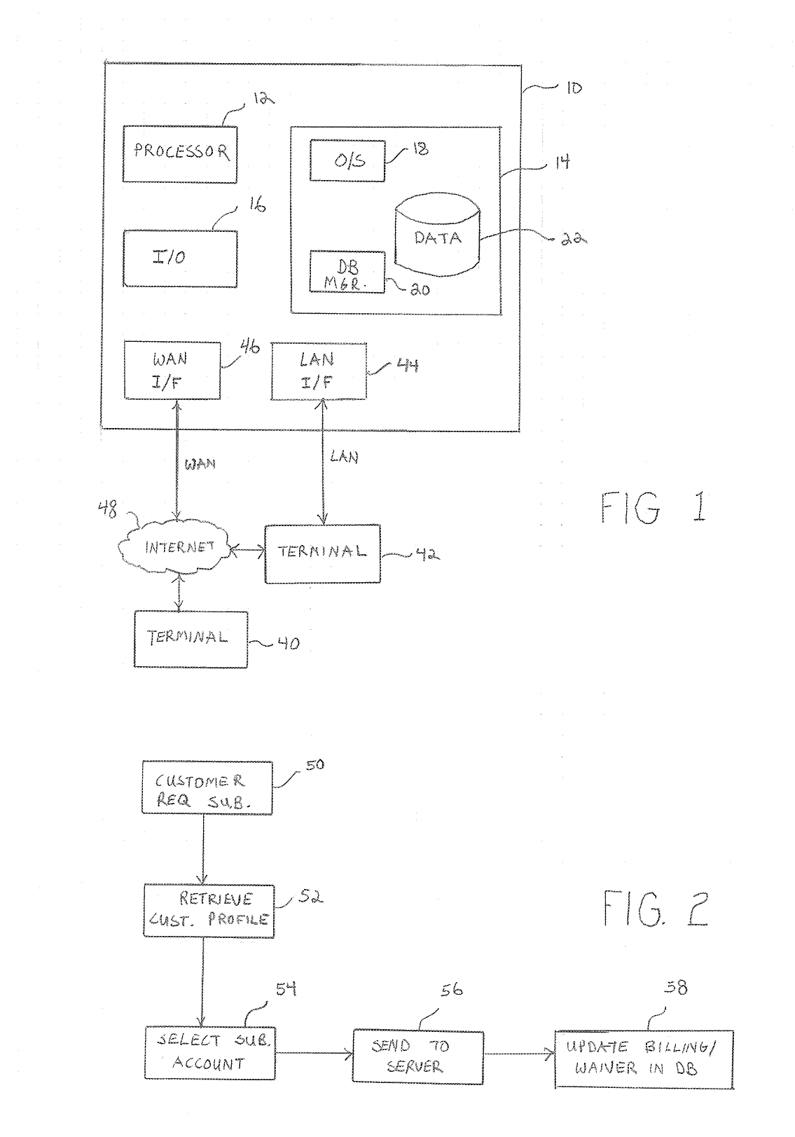

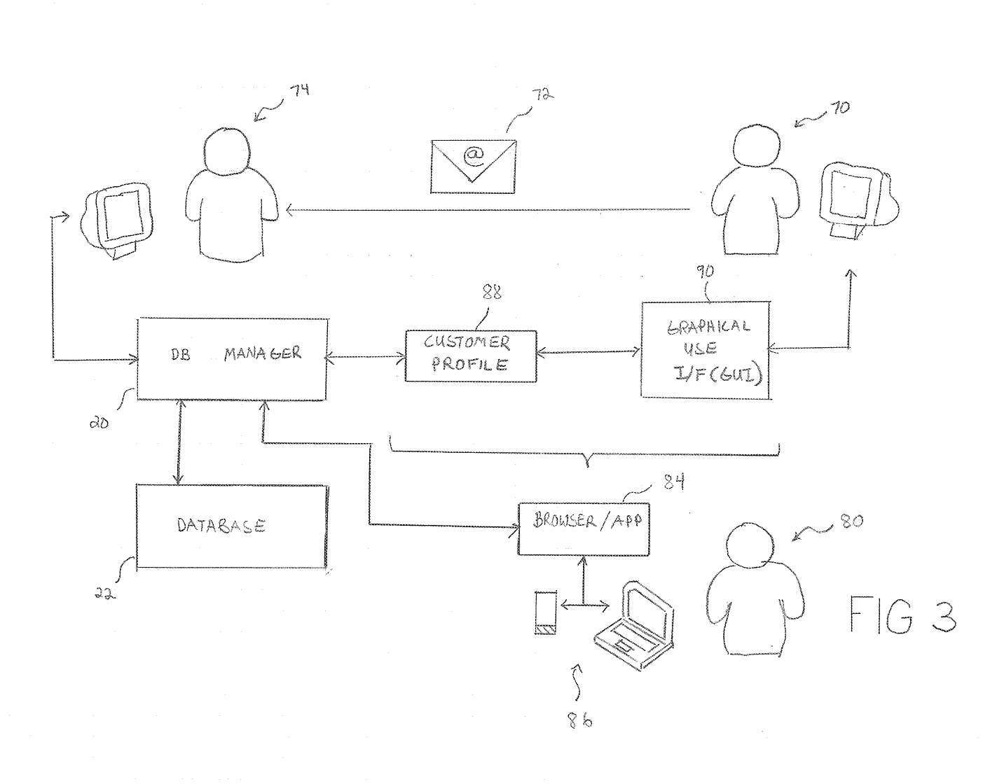

Processes in accordance with the principals of the preferred embodiments may include one or more features of processes illustrated in FIGS. 2 and 3. For sake of illustration, the processes illustrated in FIGS. 2 and 3 will be described as being performed by a system. The system may involve one or more of the devices shown in FIG. 1, in one or more individuals or users, customers, or users either individually or among a group of individuals within a household. The system may be provided by an entity. The entity may be an individual, an organization or any other suitable entity, such as a financial institution or bank.

FIG. 2 illustrates the data and logic flow diagram of an apparatus, system and method for managing financial accounts. Specifically, FIG. 2 shows the methodology, or process flow beginning when a customer requests a flat-fee subscription service for his or her financial accounts, or a household of financial accounts. The customer can request the subscription 50 by either going into the financial institution and requesting a banker to request the subscription, or can formulate the request on the user's browser or through a rendered application at, for example, terminal 40 communicated through Internet 48 to the WAN interface 46. Alternatively, the customer could go to a banker at a financial institution, or bank, and formulate the request at a terminal at the bank site, such as terminal 42, and forward that request to the LAN interface 44. As a further alternative, the customer could use a terminal 42 at the bank site, but formulate the request via a browser of terminal 42 through Internet 48. The customer can submit a request for the subscription by downloading an application program to his or her computing device, such as terminal 40 or terminal 42 and, by completing various fields presented by the application program as a GUI, the customer can submit the request via the application program.

Once the request for a flat-fee subscription service is made, the computing device at the financial institution, such as computing device 10 retrieves a customer profile 52. The customer profile can be retrieved from memory 14 of computing device 10. The profile can include, for example, various types of customer information such as the name, identification number, address, etc. Moreover, the customer profile can include a list of financial accounts attributable to that customer or household. Like the customer profile, the financial accounts are stored in memory 14, and specifically database 22, of computing device 10, and managed by a database manager 20 via instructions from the corresponding terminal 40 and/or 42. When a customer requests a subscription to the flat-fee subscription service herein, the customer or a banker must first retrieve the customer profile 52, and the customer profile is sent to either terminal 40 or terminal 42 depending on Whether it is sent across a WAN or a LAN.

Included with the customer profile retrieved at step 52, is a field that the customer or a banker associated with the flat-fee subscription service offered by the bank or financial institution can then enter an indicator, or any form of information into that field that would then indicate that the flat-fee subscription service is being selected 54. The process shown by steps 50 through 54 is that involving the enrollment process, and specifically the process for enrolling into the flat-fee subscription service. In addition to placing information into the indicator field presented to terminals 40 and 42, and specifically the GUI presented at those terminals, the computing device 10 will receive the indicator to instruct the subscription service enrollment. Other fields can also be presented on that GUI that would allow a customer or banker to remove account numbers to unsubscribe, edit to change billing accounts, as well as other edits to the customer profile, if needed.

On a periodic basis, such as nightly, the indicator entered into the indicator field, as well as any other data items or instructions, are sent from, for example, one portion of computing device memory 14 to another portion as, for example, a batch download. The nightly batch can occur Monday through Friday and would include the customer name, customer information file, billing account numbers and customer accounts that are to be linked and included in the fiat-fee subscription service. Thus, as shown by step 56, the nightly batch can occur from, for example, the customer-level portion of computing device memory 14, or possibly some other computing device having a memory to an account-level portion of computing device memory 14. Accordingly, as shown by step 56, the batch file can be sent to an account-level portion of a database, either the same database or a different database than the customer-level portion.

The batch file being sent to the server as shown by step 56 can also include the start date, billing frequency and, specifically, the fee waiver and duration, as well as the canceled date as shown by block 58. Thus, the customer-level portion of a computing device that is batch downloaded to the account-level portion will contain update billing/waiver information that is stored in the database, shown by step 58 as a master file in the database segment which is viewable by either the banker or the customer at terminals 40 and 42 so that the banker or customer can confirm the subscription status of a customer.

Turning now to FIG. 3, a schematic diagram of a system used to enroll and manage financial accounts, and fees associated therewith, either through email, a browser or a mobile application is illustrated. Shown in FIG. 3 are two ways in which a person can retrieve customer profile information and enroll a bank customer into the flat-fee subscription service. According to one methodology, a banker 70 located at a branch bank can forward an email 72 to another banker 74 proximate to the computing device having the database manager and database shown in FIG. 1. The email 72 can instruct banker 74 to retrieve the customer information requested by customer 80, for example. When customer 80 goes to the branch banker 70 with such instructions, banker 70 can then communicate in various ways, such as, for example, an email 72 to instruct banker 74 to enroll the customer 80 into the flat-fee subscription service.

Alternatively, customer 80 can access his or her profile through a browser or application program 84 and, upon computing device 86, the customer can enter the indicator into the presented indicator field to form the enrollment instruction. Thus, customer 80 can receive customer profile 88 upon, for example, a GUI 90. GUI 90 is then sent to customer 80 or banker 70 depending upon who was performing the request. Once the customer or banker enters into the appropriate field the instruction for enrollment, that information is sent to database manager 20 directly or through a banker 74 local terminal, such as terminal 42 shown in FIG. 1.

The information sent to the database manager for backroom operations can include the customer name, the customer information file of the subscriber, the billing account number and various instructions on actions that are needed, such as adding a new subscriber changing billing account and deleting a subscriber. That information that is sent to the database manager can be nightly batched to database 22. Moreover, the information can be subsequently extracted and presented back to the customer 80 or banker 70 via the GUI 90, so that the customer or banker can see the subscription status of that customer. And, if necessary, the banker or customer can add and edit the customer information, including the status of the flat-fee subscription hereof. Moreover, the customer can view the various financial accounts that have been linked to a single flat-fee subscription service and see all of the various fees in the account history, as well as various fees that have been waived in favor of the subscription service. A customer can therefore verify his/her account history and, if enrolled, the subscription service as having been applied across multiple financial accounts and the waiver of individual fees associated with those accounts. Verification can be sent to the browser or application program 84 onto the stationary or portable computing device 86 of customer 80.

Accordingly, the database manager, or some other portion of a computing device can hold customer information described above as well as a list of financial accounts, account details, etc. On a screen, and specifically a GUI, presented by the database manager, indicator fields can therefore be presented to allow a customer to enter alphanumeric characters in order to subscribe to the flat-fee subscription service. If enrollment is completed, a field can be presented to display a billing account number for that flat-fee subscription service.

To complete enrollment, however, the batch file is sent to the database on a regular basis, such as nightly. That portion of the database, or a portion of the database manager can be reserved for the account level portion of the computing device. The batch file can indicate not only customer information, but also various financial accounts including the primary billing account and the secondary waiver accounts. A relationship code is used to determine account eligibility for billing and waiver purposes. There may be certain primary accounts that are not subject to waiver, where secondary accounts may be subject to waiver. Eligible accounts that have fees that can be waived include certain personal accounts, such as checking accounts, health savings accounts, money market accounts, for example. All such accounts for that user or within a household can be merged and certain accounts are eligible for billing, possibly through a single account, such as a savings account or a checking account. Moreover, there are certain accounts may not be eligible for either billing or waiver, such as DBA (doing business as) accounts, AGN (agent), AKA (also known as), BEN (beneficiary), POA (power of attorney), to list a few.

Accounts that are eligible for either billing or waiver may include a flag, possibly consisting of one or more data bits that can be sent to a banker or customer to provide feedback as to which financial accounts are linked to one another under a subscription account, for billing and waiver purposes. Accordingly, flags can be set to indicate the subscription service is invoked on certain financial accounts that have been merged and billed through a specific financial account. Flags will indicate fees associated with certain financial accounts as having been waived as a result of the enrollment into the “all you can eat” flat-fee subscription service hereof.

The acceptance criteria of the enrollment process begins after the periodic (e.g., nightly) batch download. For customer profiles having the flat fee subscription service, certain fee waivers to eligible accounts on that customer information file profile are applied. Certain eligible account types and non-eligible account types are sent back to the customer for verification and to indicate the enrollment and which fees for various accounts will be waived and which financial account will receive periodic debit of the subscription service.

Although preferences can change, certain fees can be waived on selected ones of the financial accounts that are linked to the flat-fee subscription service. For example, certain monthly fees, usage-based fees, balance-based fees of each of the linked accounts can be waived, including but not limited to waiver of stop-pay fee, overdraft transfer fee, wire transfer charges, monthly service charge, online bill pay subscription charge, ATM inquiry fees, signature verification fees, statement print out fees, savings withdrawal fees, etc. Such fees are normally associated as “nuisance fees” which are normally attributed to each account and are advantageously waived when a customer enrolls into the flat-fee subscription service across all linked financial accounts.

Thus, apparatus, systems and methods for waiving a fee for a banking service have been provided. A person skilled in the art will appreciate that the present invention can be practiced by other than the described embodiments, which are presented for purposes of illustration rather than of limitation. The present invention is limited only by the claims that follow.

What is claimed:

1. An apparatus for managing financial accounts, comprising:
a database comprising data corresponding to at least two financial accounts having a relationship code; and
an input/output device coupled to the database for receiving an instruction to fetch the relationship code and to link the at least two financial accounts to a flat fee subscription service whereby a set of fees associated with the at least two financial accounts are waived.

2. The apparatus as recited in claim 1, further comprising:
a database manager coupled between the database and the input/output device; and
a graphical user interface (GUI) produced by the input/output device and configured for receiving the instruction either over a wide area network or a local area network.

3. The apparatus as recited in claim 1, wherein the financial accounts are selected from a group consisting of checking accounts, savings accounts, money market accounts and brokerage accounts.

4. The apparatus as recited in claim 1, wherein the financial accounts comprise one or more checking accounts and/or savings accounts.

5. The apparatus as recited in claim 1, wherein the flat fee subscription service applies a periodic single said flat lee to the at least two financial accounts.

6. The apparatus as recited in claim 1, wherein the set of fees are selected from a group consisting of a stop pay fee, overdraft transfer fee, wire transfer fee, electronic bill pay fee.

7. The apparatus as recited in claim 1, wherein the set of fees comprise least a stop pay fee, an overdraft transfer fee, and a wire transfer fee.

8. A system for managing financial accounts, comprising:
a server including:
a database comprising data corresponding to at least two financial accounts;
a database manager operatively coupled to assign a flag to the at least two financial accounts;
a terminal; and
a wide area network (WAN) coupled between the server and the terminal for receiving an instruction from the terminal to the database manager for linking the at least two financial accounts and for assigning the flag to the at least two financial accounts indicating waiver of a set of fees associated with the at least two financial accounts.

9. The system as recited in claim 8, wherein said WAN comprises the Internet.

10. The system as recited in claim 8, wherein said server comprises a web server.

11. The system as recited in claim 8, said flag comprises at least one binary bit of information.

12. The system as recited in claim 8, wherein said terminal comprises a computer or a mobile phone.

13. A method for managing at least two financial accounts, comprising:
enrolling the at least two financial accounts into a flat fee subscription service where the flat fee is payable on a regular, periodic basis;
setting a flag associated with the at least two financial accounts indicating a waiver of a set of fees associated with both the at least two financial accounts during the time in which the flat fee is paid; and
billing a customer the flat fee on the regular, periodic basis.
